(19) United States
(12) Patent Application Publication
(10) Pub. No.: US 2010/0324155 A1
(43) Pub. Date: Dec. 23, 2010

(54) PREPARATION OF INORGANIC FOAM

(75) Inventors: Anthony K. Burrell, Los Alamos, NM (US); Thomas M. McCleskey, Los Alamos, NM (US); Quanxi Jia, Los Alamos, NM (US); Eva Bauer, Los Alamos, NM (US); Karen J. Blackmore, Los Alamos, NM (US); Alexander H. Mueller, Santa Fe, NM (US); Matthew Dirmyer, Santa Fe, NM (US)

Correspondence Address: LOS ALAMOS NATIONAL SECURITY, LLC, LOS ALAMOS NATIONAL LABORATORY, PPO. BOX 1663, LC/IP, MS A187, LOS ALAMOS, NM, 87545, US

(73) Assignee: LOS ALAMOS NATIONAL SECURITY, LLC, Los Alamos, NM (US)

(21) Appl. No.: 12/871,558

(22) Filed: Aug. 30, 2010

Related U.S. Application Data
(63) Continuation-in-part of application No. 11/804,472, filed on May 17, 2007.
Application No. 11/804,472 is a continuation-in-part of application No. 10/888,868, filed on Jul. 8, 2004, now Pat. No. 7,604,839.
Application No. 10/888,868 is a continuation-in-part of application No. 10/616,479, filed on Jul. 8, 2003, now Pat. No. 7,365,118.

(51) Int. Cl. B01F 3/04

(52) U.S. Cl. 516/11

(57) ABSTRACT

A solution of soluble metal, soluble polymer, and a suitable solvent is converted into a gel body having a surface area to volume ratio no greater than 10. The gel body is converted to inorganic foam. Foams of metal oxide, metal nitride foam, metal carbide foam, metal selenide, and elemental metal were prepared. Several of the foams are (a) molybdenum carbide and molybdenum nitride, (b) TiO, (c) copper selenide, (d) copper indium selenide, (e) molybdenum carbide, molybdenum nitride, and platinum, and (f) ruthenium dioxide.

### RELATED APPLICATIONS

This application is a continuation-in-part of copending U.S. Ser. No. 11/804,472 entitled “Polymer-Assisted Deposition of Films,” by McCleskey et al., which is continuation-in-part of U.S. Ser. No. 10/888,868 entitled “Polymer-Assisted Deposition of Films,” filed Jul. 8, 2004, by McCleskey et al., now U.S. Pat. No. 7,604,839, which is a continuation-in-part of U.S. Ser. No. 10/616,479 entitled “Polymer-Assisted Deposition of Films,” filed Jul. 8, 2003, by McCleskey et al., now U.S. Pat. No. 7,365,118, all incorporated by reference herein.

### STATEMENT REGARDING FEDERAL RIGHTS

This invention was made with government support under Contract No. DE-AC52-06NA25396 awarded by the U.S. Department of Energy. The government has certain rights in the invention.

### FIELD OF THE INVENTION

The present invention relates generally to the preparation of foams of inorganic materials such as metal oxides, metal carbides, metal nitrides, and elemental metal.

### BACKGROUND OF THE INVENTION

Inorganic foam has applications in catalysis, lightweight structural materials, semiconductors, thermal management, gas sensing, solar cells, batteries, electrodes, and in other areas. Examples of foams of inorganic materials that have been prepared include foams of tin oxide, titanium oxide, vanadium oxide, and vanadium nitride.

### SUMMARY OF THE INVENTION

In accordance with the purposes of the present invention, as embodied and broadly described herein, the present invention includes a method for a process for preparing inorganic foam. According to the process, a solution including a soluble metal precursor, a soluble polyethyleneimine, a suitable solvent is prepared, and ethylenediaminetetraacetic acid or a salt (a sodium salt or potassium salt, for example) thereof. The solution is subjected to ultrafiltration to produce a concentrated solution, which is heated in a container to form a gel body having a surface area to volume ratio no higher than 10. The gel body is heated in the container under an atmosphere of flowing gas at temperatures sufficient to remove the solvent, and decompose and remove the polyethyleneimine, whereby inorganic foam is produced. In some cases, the ultrafiltration step is optional.

### BRIEF DESCRIPTION OF THE DRAWINGS

The accompanying drawings, which are incorporated in and form a part of the specification, illustrate the embodiments of the present invention and, together with the description, serve to explain the principles of the invention. In the drawings:

FIG. 1 shows a X-ray Powder diffraction pattern for a ZnO foam prepared according to the procedure of Example 10.

FIG. 2 shows a spectrum of the ZnO foam of FIG. 1.

FIG. 3 shows an X-Ray powder diffraction pattern for copper foam prepared using the procedure of Example 16.

FIG. 4 shows an X-Ray powder diffraction pattern for the mixed molybdenum carbide-nitride foam prepared using the procedure of Example 5.

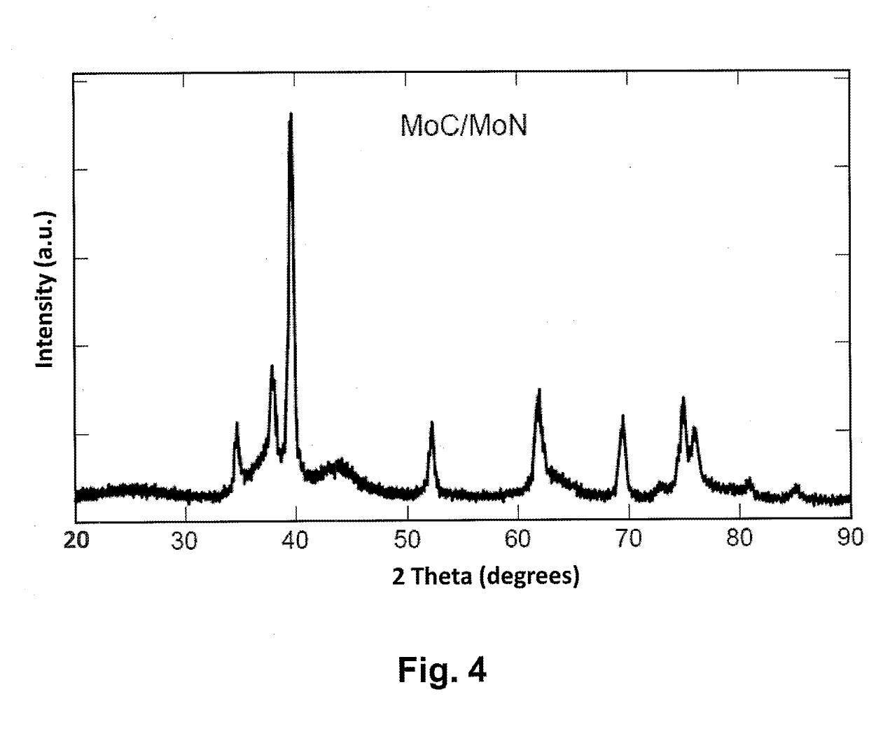

FIG. 5 shows and X-Ray powder diffraction pattern for the mixed molybdenum carbide-nitride foam that contains platinum prepared using the procedure of Example 4.

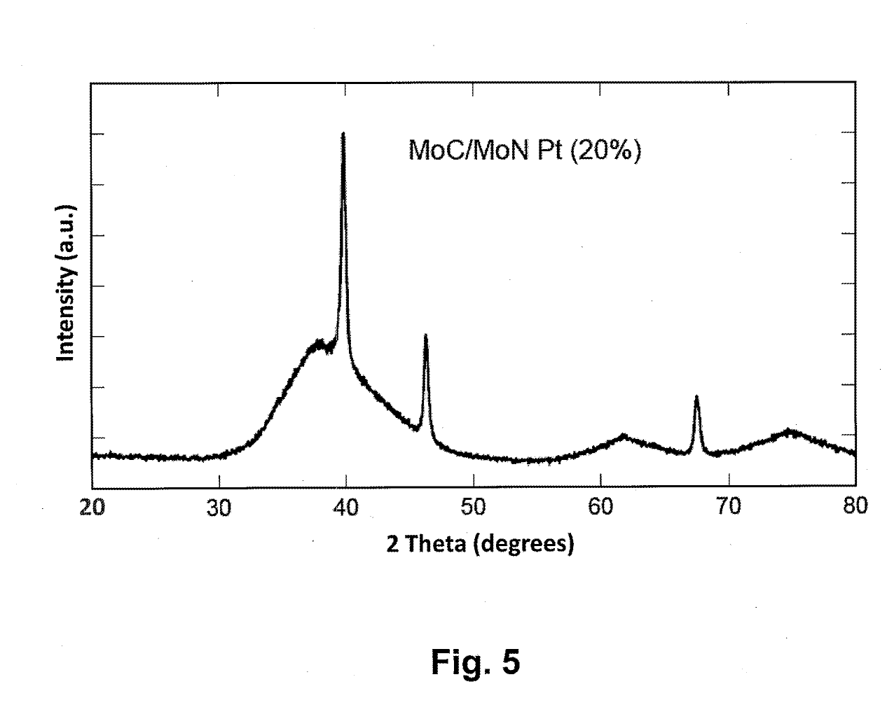

FIG. 6 shows an X-Ray powder diffraction pattern for sub oxide titanium, i.e. TiO₂₋ₓ wherein 1<x<2, prepared using the procedure of Example 6.

FIG. 7 shows an X-Ray powder diffraction pattern for TiO foam prepared according to the procedure of Example 7.

### DETAILED DESCRIPTION

Metal foams are compositions of metals, metal oxides, metal nitrides, metal carbides, metal selenides having a surface area greater than 10 meters squared per gram (m² g⁻¹). The invention is concerned with the preparation of these foams. The invention is also concerned with foams having a surface of 10 m² g⁻¹ having the following compositions: (a) molybdenum carbide and molybdenum nitride, (b) TiO, (c) copper selenide, (d) copper indium selenide, (e) molybdenum carbide, molybdenum nitride, and platinum, and (f) ruthenium dioxide.

The foam preparation involves preparing a homogeneous solution including soluble polymer, soluble metal, and a suitable solvent. In most cases, ethylenediaminetetraacetic acid (H₄EDTA), or a salt of ethylenediammineacetic acid (Na₂H₂EDTA, for example) is also added, and is believed to form a complex with the metal. By soluble, it is meant that the soluble material dissolves in the solvent to form a solution, which a single phase called the solution phase. The solution was subjected to conditions for converting the solution into a gel body having a surface area to volume ratio no greater than 10. The gel body was heated in a container under heating conditions resulting in decomposition of the polymer and H₄EDTA (or salt thereof) if present. The decomposition produced gas. The result is conversion of the gel to foam.

A soluble metal is a form of the metal that is soluble in the solvent. Elemental metal is typically insoluble. Salts of metals are soluble. For the purposes of this invention, a soluble metal is typically a metal salt (zinc chloride, vanadyl sulfate, ruthenium chloride, ammonium molybdate tetrahydrate, for example). The solution may also include various ligands, which are chemical species that may form bonds to a metal. Depending on the solvent and the soluble metal, molecules of solvent may be ligands that form bonds to the metal.

Anions may also be ligands. Examples of anions that may be ligands include, but are not limited to, fluoride, chloride, bromide, iodide, hydroxide, alkoxide (methoxide, ethoxide, for example), acetate, cyanide, anions of ethylenediaminetetraacetic acid, isocyanate, thiolate, and the like. These anions may bind to a metal ion.

Ligands may be neutral organic molecules such as amines, alcohols, and organic acids (H₄EDTA for example) that contain atoms having a localized pair of electrons that can interact with a metal ion and form a complex with the metal ion. A molecule that can do this is sometimes referred to as a Lewis base, the metal ion sometimes being referred to as a Lewis acid, and the interaction is sometimes referred to as a Lewis base—Lewis acid interaction. The receiver is the Lewis acid and the donor is the Lewis base, and what forms is a Lewis acid—Lewis base complex. Ethanol, ammonia, and H₄EDTA are examples of neutral ligands.

In an aspect of this invention, a solution of a soluble metal, soluble polymer, and solvent is prepared and then heated to evaporate solvent to form a gel body, which is more viscous than the solution. The gel body is heated under a flow of gas. The heating promotes removal of solvent, decomposition of the polymer and formation of a gas. The inorganic foam produced may be a metal oxide foam, a metal nitride foam, a metal carbide foam, a metal selenide foam or a foam of elemental metal, i.e. a metallic foam.

The polymer should be soluble and have a clean decomposition when heated above its decomposition temperature. In an embodiment, the gel body is heated under calcination conditions which are conditions that involve heating the gel body under an oxidizing atmosphere. Under calcination conditions, the polymer should decompose cleanly so that metal oxide foam that is free from side products is produced.

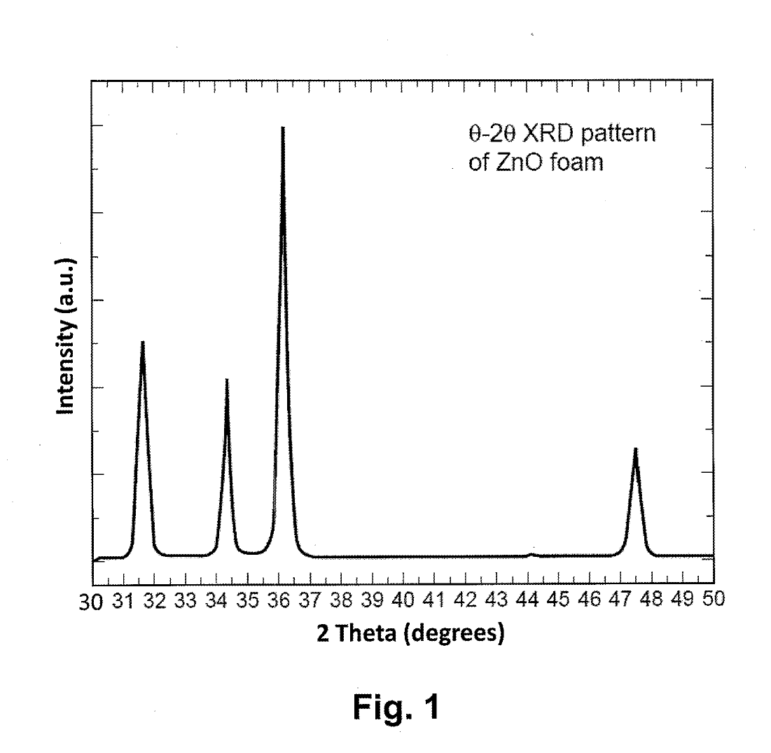

In an embodiment, zinc oxide foam was prepared from an aqueous methanol solution containing a soluble zinc precursor and polyethyleneimine (PEI). The solution was prepared by dissolving a salt of EDTA of the formula K₂H₂EDTA in water followed by the addition of zinc chloride and the PEI. The solution was purified by Amicon ultrafiltration to remove the sodium and chloride ions. Heating the solution inside a container resulted in evaporating most of the water from the solution and formation of a gel body. The container and gel body were transferred to a tube furnace and an oxidizing atmosphere. Such an atmosphere can range from air to pure oxygen. The tube furnace was then heated to form the foam. Due to the volume of the sample (½ inch×½ inch×3 inches), and the value of 2 for the surface area to volume ratio, and the large amount of gas release due to decomposition of K₂H₂EDTA and polyethyleneimine, the solid expanded significantly in volume and the zinc oxide crystallized in a very high surface area foam. An X-ray diffraction pattern (XRD) for the zinc oxide foam is shown in FIG. 1. The XRD pattern is the same pattern for zinc oxide prepared by other methods.

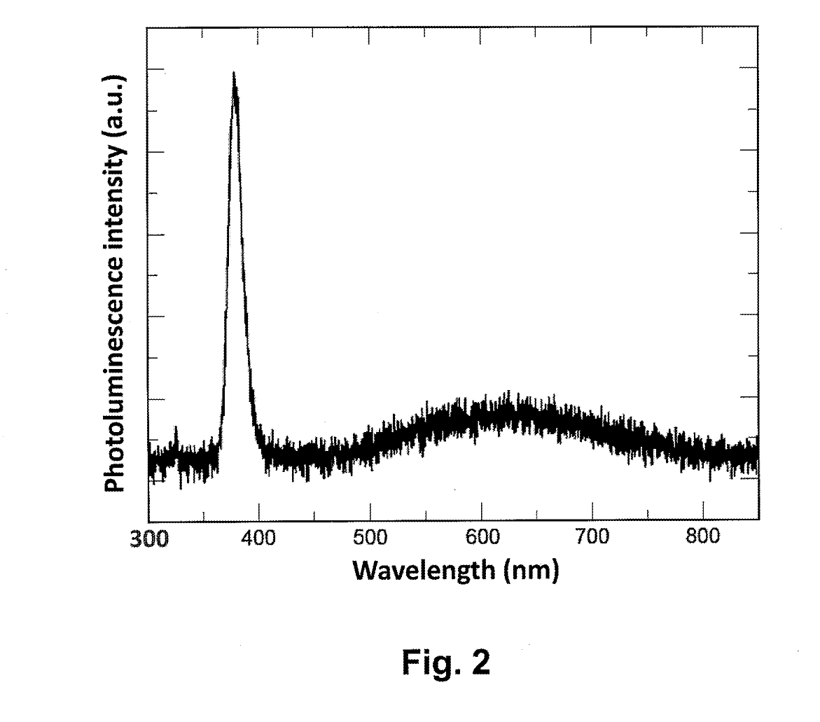

A spectrum of the zinc oxide foam is shown in FIG. 2. The zinc oxide foam is a semiconductor. The surface area of the foam was 100 m² g⁻¹.

The method may be used to produce metal oxides of other metals. All metals, including but not limited to main group metals, transition metals, lanthanides and actinides, that are capable of forming metal oxides, including mixtures of these metals, may be used to prepare foams.

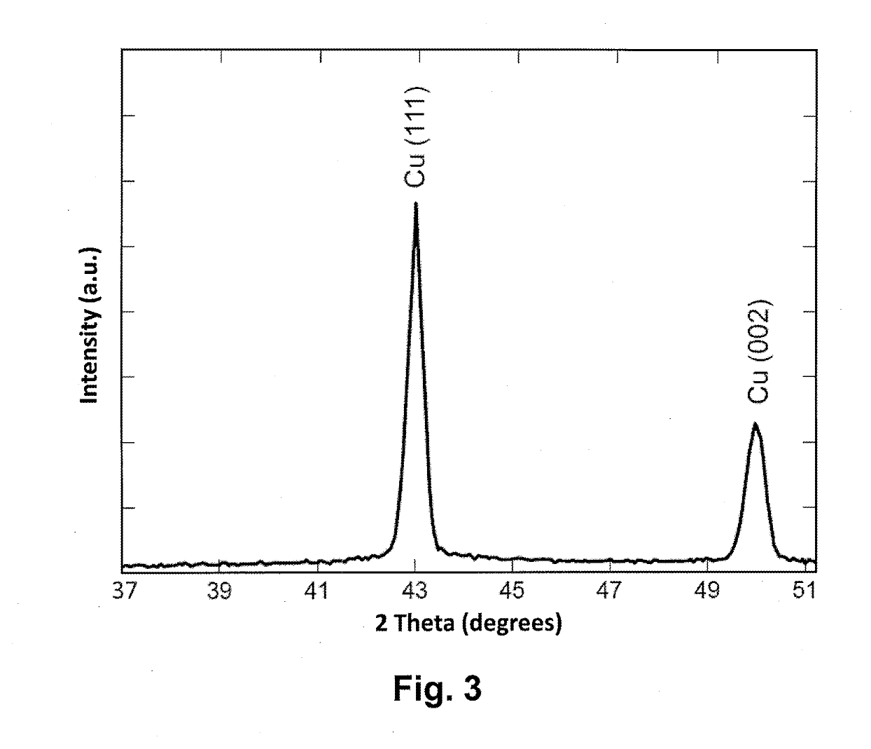

In an embodiment, elemental copper foam was prepared from an aqueous solution containing a soluble copper precursor and PEI. The solution was prepared by dissolving K₂H₂EDTA in water followed by the addition of copper nitrate. The solution may optionally be purified by Amicon ultrafiltration to remove the nitrate ions. The solution was placed into a container, and after evaporating most of the water from the solution a gel body was produced. The container and gel body were transferred to a tube furnace. The body, which has a surface to volume ratio no higher than 10, was exposed to an atmosphere of a mixture of inert gas and hydrogen. The container and gel body were heated to convert the gel body into foam. Due to the surface area to volume ratio and large amount of gas released during thermal decomposition, the solid expands significantly in volume and elemental copper foam was produced. An X-ray diffraction pattern (XRD) for the metallic copper foam is shown in FIG. 3. This XRD pattern shows that the product was elemental copper. Elemental metal foams of copper, silver gold, niobium, germanium, tin, iron, molybdenum, chromium, ruthenium, iridium, rhodium, nickel, platinum and palladium may be produced using this method.

In an embodiment, mixed metal-carbides and nitrides can be prepared under hydrogen atmospheres from metals where the reducing atmosphere is not sufficient to produce the elemental metal. For example, a foam mixture of molybdenum carbide and nitride was obtained when 4% hydrogen in argon (4% H₂ in nitrogen) gas was employed to reduce a solution of a molybdenum precursor. The solution of molybdenum precursor was prepared by dissolving ammonium molybdate tetrahydrate dipotassium, ethylenediaminetetraacetic acid and polyethyleneimine in water. This solution may be purified by Amicon ultrafiltration to remove the ammonium ions. After evaporating most of the water from the solution a gel body was produced. This gel body, having a surface to volume ratio no greater than 10, was transferred to a tube furnace and 4% hydrogen in argon or nitrogen, was introduced. The furnace was then heated under this atmosphere to form the foam. The surface area of these foam generally exceed 50 m² g⁻¹. The carbon and nitrogen are believed to originate from the PEI and/or H₄EDTA or salt thereof.

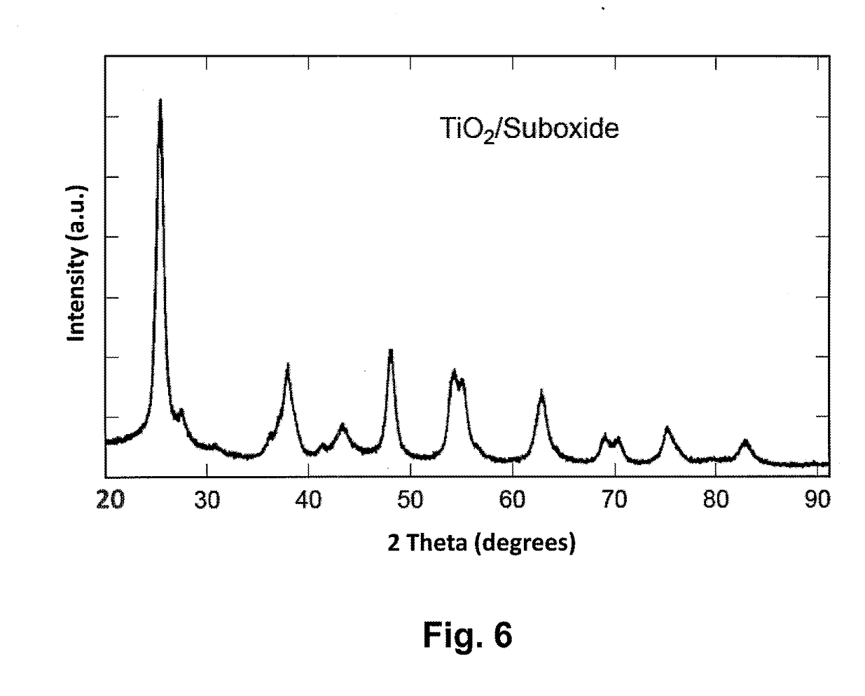

A foam mixture of metal carbide, nitride and elemental metal may be formed under reducing conditions. In an embodiment, a mixture of soluble molybdenum and platinum was used to produce a foam mixture of molybdenum carbide and molybdenum nitride with elemental platinum metal incorporated into the foam. An XRD spectrum of this foam is shown in FIG. 6. The molybdenum carbide/nitride and the platinum metal reflections are present, and energy-dispersive X-ray spectroscopy confirmed the presence of these materials. Foams of a large number of combinations of nitrides, carbides and metals containing different mixtures of the main group metals, transition metals, lanthanides and actinides may be formed. Foams of metal carbides or nitrides including the elemental metal may have important applications in catalysis.

In an embodiment, a solution of ammonium molybdate tetrahydrate, H₄EDTA and PEI in water was prepared, purified by Amicon ultrafiltration to remove the ammonium ions, and then evaporated in a container to remove most of the solvent. A gel body formed in the container. The gel body had a surface area to volume ratio no larger than 10. The container and gel body were transferred to a tube furnace. A gas mixture of 4% hydrogen in argon or nitrogen was introduced, followed by an ammonia atmosphere. The furnace was then heated under this atmosphere to form the foam. The method may be used to form nitrides from the main group metals, transition metals, lanthanides and actinides.

Metal-carbides may be prepared under carbon atmospheres. In an embodiment, a molybdenum solution was prepared by dissolving ammonium molybdate tetrahydrate dipotassium, H₄EDTA, and PEI in water. This solution was purified by Amicon ultrafiltration to remove the ammonium ions. After evaporating most of the water from the solution, a gel body produced having a surface to volume ratio no larger than 10. This gel body and container in which it was formed were transferred to a tube furnace and 4% hydrogen in argon or nitrogen, was introduced followed by an ethylene atmosphere. The furnace was then heated under this atmosphere to form the foam. Other metal carbides, which have main group metals, transition metals, lanthanides and actinides, may be formed using the method.

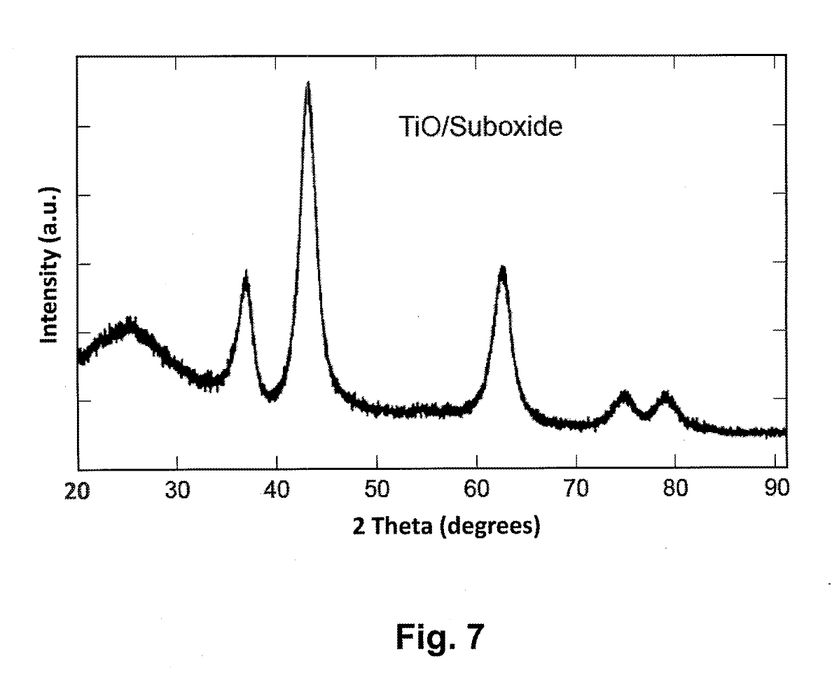

In an embodiment, metal sub oxides can also be prepared under hydrogen atmospheres from metals where the reducing atmosphere is not sufficient to achieve the elemental metal state, and carbide or nitride formation is not favorable. For example, titanium sub-oxide foam was formed using 4% hydrogen in argon or nitrogen gas to reduce a titanium precursor. An XRD of the TiO₂₋ₓ foam obtained is shown in FIG. 6, and is identical to the XRD obtained for TiO₂₋ₓ prepared from other methods. The length of time at the high temperatures, generally 900° C., has a significant effect on the relative oxidation state of the titanium. If the heating time under 4% hydrogen in argon is only 3 hours the material composition was TiO₂₋ₓ, 1<x<2. If the heating time is extended to 8 hours the TiO₂₋ₓ, where X=1, (or TiO) is obtained. The TiO is black and conductive and the XRD pattern shown in FIG. 7 is identical to TiO prepared using other methods. The surface area of these suboxide foams generally exceed 50 m²g⁻¹ and often exceed 200 m² g⁻¹.

In an embodiment, metal selenides were prepared under selenium atmosphere. In this embodiment, an indium solution was prepared and evaporated to form a gel body that was transferred to a tube furnace and 4% hydrogen in argon was introduced (4% H₂ in nitrogen could also be used). The tube furnace was then heated and diethylselenide was added to the gas to form the copper selenide foam. In another embodiment, indium precursor is added to the copper solution before formation of the gel body which is then heated in the presence of the diethylselenide the produce is copper indium selenide. These materials have surface areas greater than 10 m² g⁻¹. XRD patterns of the foams spectra match spectra of these materials prepared using other methods. If the gas were changed from diethylselenium to sulfur, sulfides would result. Tellurides would be produced using diethyltellurium. Sulfides, selenides and tellurides of other metals such as transition metals, main group metals, lanthanides and actinides can also be prepared.

Polyethyleneimine (PEI) is a polymer that has been used in various embodiments of the preparation of inorganic foams. PEI was chosen because it is a soluble polymer, it is compatible with the soluble metal used in the preparation, and it binds to the soluble metal. It may bind to the soluble metal through any of various mechanisms such as electrostatic attraction, hydrogen bonding, covalent bonding and the like. PEI is useful for preparation of inorganic foams according to the present process because PEI has suitable interactions with the soluble metal that prevent phase separation. PEI also undergoes a clean decomposition upon heating at high temperatures, e.g., temperatures over about 250° C. PEI decomposes completely and cleanly above 250° C. and leaves little or no residual carbon in the film.

Besides PEI, other polymers that are useful for preparing inorganic foam according to this invention include derivatives of PEI such as but not limited to, carboxylated-polyethylenimines (PEICs), acylated-polyethylenimines, and hydroxylated water-soluble polyethylenimines. These other derivatives of PEIs may also be used as the soluble polymer. In addition, other polymers capable of binding metals can be used. For example, polyacrylic acid was used in the preparation of ruthenium oxide foam.

Inorganic foam includes inorganic metal oxides and inorganic metal nitrides. Metal oxide foam may include a metal oxide with a single metal. Metal oxide foam may include two metals. Metal oxide foam may include three metals. Metal oxide foam may include four or more metals. Among the various embodiment metal oxide foam that can be prepared by the present process are included metal oxide from Groups 3, 4, 5, and 6 of the periodic table of the elements, as well as the oxides of silicon and aluminum. These oxides include silicon oxide, titanium oxide, niobium oxide, vanadium oxide, tungsten oxide, and tantalum oxide. Oxides with two metals include titanium oxide/niobium oxide, titanium oxide/vanadium oxide, titanium oxide/tantalum oxide, niobium oxide/vanadium oxide, niobium oxide/tantalum oxide, vanadium oxide/tantalum oxide, and the like. Oxides with three metals include titanium oxide/niobium oxide/vanadium oxide. Oxides with four metals include titanium oxide/niobium oxide/vanadium oxide/tantalum oxide.

Foams of tin, vanadium, nickel, germanium, molybdenum, platinum, titanium, zirconium, zinc, ruthenium, aluminum, uranium, copper, and mixtures thereof have been prepared.

Solvents for dissolution of the soluble PEI or PEI-derivative polymer can be, for example, water, lower alcohols such as methanol, ethanol, propanol and the like, acetone, propylene carbonate, tetrahydrofuran, acetonitrile, acetic acids and mixtures thereof such as water and methanol, water and ethanol, water and acetone, and the like. As the soluble polymer used in the present invention includes binding properties for the metals or metal precursors used in formation of the metal oxide oxides, the polymer can help provide the necessary solubility for dissolving the respective soluble metals. By soluble metal is meant a metal in a form that is soluble in the solvent. A soluble metal is typically an ionized form, i.e. in the form of a metal ion.

The starting solution is typically prepared and maintained at room temperature, which is from about 15° C. to about 30° C., more usually from about 20° C. to about 25° C. Within those temperature ranges and above the higher temperature, the materials added to the solution are soluble.

In preparation of homogeneous solutions used in the preparation of metal foams, the solutions using PEI or a PEI derivative as the metal binding polymer can be filtered prior to use to remove any non-soluble components. In addition, a solution containing metal and a polyethyleneimine may be subjected to ultrafiltration using, for example, AMICON ultrafiltration unit containing an ultrafiltration membrane. Such membranes are designed to pass materials have a molecular weight less than some predetermined molecular weight. One such membrane may be designed to pass materials having a molecular weight of less than 3,000 grams/mole (e.g., unbound metal, smaller polymer fragments and the like) while retaining the desired materials of a larger size. Another such membrane may be designed to pass materials having a molecular weight less than 5,000 grams/mole. Yet another such membrane may be designed to pass materials having a molecular weight less than 10,000 grams/mole. Ultrafiltration allows for removal of any unwanted salts such as cations, anions or other impurities. Ultrafiltration also allows removal of polymers having a molecular weight lower than the threshold for the membrane (e.g. a PEI having molecular weight of 10,000, for example).

The metal ratio can be controlled through appropriate addition of metal precursors to a solvent used in the deposition. Such solutions can generally have a shelf life of more than a year.

Heating of the gel body may take place from about 100° C. to about 1300° C., or from about 120° C. to about 1200° C., or from 250° C. to about 1000° C., or from about 250° C. to about 900° C., or from about 250° C. to about 750° C., or from about 250° C. to about 700° C., or from about 350° C. to about 750° C., or from about 350° C. to about 700° C. Heating may take place under a flow of gas for a period of time sufficient to remove the solvent and the polymer (and H₄EDTA or salt thereof, if present) and form inorganic foam. These foams can be brittle substances.

If the flow of gas is an oxidizing gas, then the conditions are calcination conditions and the gel body is converted into metal oxide foam. Other gas flows of gas have been shown to result in conversion of the gel body into metal nitride foam. Gases that result in metal nitride foams have been shown to include a high percentage (greater than 90% of nitrogen), and may also include a low percentage (less than 10%) of hydrogen (H₂) molecules. The preparation of metal nitride foam was demonstrated using a gas mixture of about 96% nitrogen and about 4% hydrogen, and a gas mixture of about 94% nitrogen and about 6% hydrogen. It is expected that metal nitride foam will result when the gas mixture is 90% nitrogen and 10% hydrogen, 91% nitrogen and 9% hydrogen, 92% nitrogen and 8% hydrogen, 93% nitrogen and 7% hydrogen, 95% nitrogen and 5% hydrogen, 96% nitrogen and 4% hydrogen, 97% nitrogen and 3% hydrogen, 98% nitrogen and 2% hydrogen, and for mixtures containing even an even larger percentage of nitrogen. Alternatively it is possible to ammonia as the nitrogen precursor.

An aspect of the invention relates to preparation of foams of metal carbides. The preparation of metal carbide foams may involve the preparation of a solution including a soluble metal, H₄EDTA and/or salt thereof, and PEI. The carbon from such foams may be derived from carbon present in any or all of H₄EDTA and/or salt thereof, and PEI. Additionally, the carbon may be derived from other carbon-containing ingredients.

Another aspect of the invention relates to the preparation of sulfides, selenides or tellurides. These materials may be prepared if the thermal process occurs in the presences of sulfur, selenium or tellurium respectively. For example copper selenide or copper indium selenide can be prepared by using diethylselenide as the selenium source.

The polymer is used to bind to the metal so that any unwanted anions or cations can be removed by filtration, e.g., through an Amicon ultrafiltration unit, and brings multiple metals together in a homogeneous manner at a molecular level. This also prevents selective precipitation of unwanted metal phases as a portion of the water can be removed and the metals concentrated within the remaining solution.

The use of the ethylenediaminetetraacetic acid (H₄EDTA), or salts of EDTA, has a beneficial impact on the surface area of the foams obtained. The foams obtained with H₄EDTA, or salts thereof, were generally of much higher surface area compared to foams that lacked H₄EDTA (or salts thereof).

The present invention is more particularly described in the following EXAMPLES, which are intended as illustrative only, since numerous modifications and variations will be apparent to those skilled in the art. In each of the following EXAMPLES involving the production of a gel body that was subsequently used to prepare foam, the gel body was formed in a container that provided the gel body with a surface area to volume ratio that was no higher than 10 or is believed to have had a surface area to volume ratio that was no higher than 10.

### EXAMPLE 1

A foam containing vanadium and cobalt was prepared according to the procedure that follows. An amount of 2.0 grams of vanadyl sulfate, whose chemical formula is VOSO₄, was dissolved in 20 mL of water. An amount of 2.0 grams of ethylenediaminetetraacetic acid (H₄EDTA) and an amount of 2.1 grams of polyethyleneimine (PEI) were added to the solution. The resulting mixture was mixed using a vortex mixer for several minutes to produce a clear, deep blue solution. The resulting solution was placed in an Amicon ultrafiltration unit containing a PM 10 ultrafiltration membrane designed to pass materials having a molecular weight less than 10,000 grams/mole. The solution was diluted to a volume of 200 mL and then subjected to ultrafiltration. Inductively coupled plasma—atomic emission spectroscopy was used to determine that the solution resulting from ultrafiltration was had a concentration of 363.4 mM in soluble vanadium.

Another solution was prepared by dissolving an amount of 2.5 grams of cobalt dichloride (CoCl₂) in 30 mL of water and then adding an amount of 2.4 grams of H₄EDTA and an amount of 2.5 grams of PEI. The resulting mixture was mixed using a vortex mixer for several minutes and the resulting solution was placed in an Amicon ultrafiltration unit containing a PM 10 ultrafiltration membrane designed to pass materials having a molecular weight less than 10,000 grams/mole. The solution was diluted to a volume of 200 mL and then subjected to ultrafiltration. The result was a solution having a concentration of 295 mM in soluble cobalt.

A 2 mL portion of the 363 mM vanadium solution and a 0.130 mL portion of the cobalt solution were combined, poured into a ceramic boat, and then the ceramic boat was heated on a hot plate at 100° C. for several hours until a thick gel body formed. The boat was then heated in a tube furnace under a flow of a gas mixture of H₂ (4%) and N₂ (96%) at a ramp rate of 1 degree Celsius per minute (1°/min) according to the following procedure: the temperature was ramped to 120° C. and then held at 120° C. for 1 hour, then ramped to 350° C. and held at 350° C. for 1 hour, and ramped to 900° C. and held at 900° C. for 3 hours, before cooling back to room temperature. A dark, brittle foam was produced with a resistance of approximately 75 ohms over 1 centimeter (cm).

### EXAMPLE 2

A foam containing vanadium and nickel (5%) was prepared according to the procedure that follows. An amount of 2.0 grams of vanadyl sulfate, which has the formula VOSO₄, was dissolved in 20 mL of water. An amount of 2.9 grams of H₄EDTA and an amount of 2.1 grams of PEI were added to the solution. The resulting mixture was mixed for several minutes with a vortex mixer to produce a clear, deep blue solution, which was subjected to Amicon filtration with five 100 mL washings. The result was a 363.4 mM vanadium solution.

Another solution was prepared by dissolving an amount of 1.25 grams of nickel dichloride in 20 mL of water, adding an amount of 3.0 grams of PEI to the solution. The resulting mixture was mixed for several minutes using a vortex mixer. The resulting solution was subjected to Amicon filtration. The result was a 143 mM nickel solution.

A 2 mL portion of the 363.4 mM vanadium solution was combined with a 0.268 portion of the 143 nickel solution and poured into a ceramic boat. The boat was heated on a hot plate at 100° C. for several hours until a thick gel body formed. The boat was then heated in a tube furnace under a flow of a gas mixture of H₂ (4%) and N₂ (96%) at a ramp rate of 1 degree Celsius per minute (1°/min) according to the following procedure: the temperature was ramped to 120° C. and then held at 120° C. for 1 hour, then ramped to 350° C. and held at 350° C. for 1 hour, and ramped to 900° C. and held at 900° C. for 3 hours, before cooling back to room temperature. A dark, brittle foam of a mixture of vanadium nitride and nickel nitride was produced with a resistance of approximately 75 ohms over 1 centimeter (cm).

### EXAMPLE 3

A foam of germanium was prepared according to the procedure that follows. An amount of 1.3 grams of Na₂H₂EDTA (ALDRICH, 99.995%) was dissolved in 25 mL water. An amount of 1.6 grams of PEI was then added and mixed to yield a clear solution. An amount of 1.20 grams of GeCl₄ (ACROS, 99.999%) was then added slowly to the clear solution. A small amount of precipitate formed. The pH was adjusted to pH 4.9 by dropwise addition of ammonium hydroxide and the resulting solution was allowed to stand overnight. A very small amount of precipitate formed, which was removed by filtration using a 0.45 micron (i.e. 0.45 micrometer) filter. The result was a clear solution that was 200 mM in Ge. This solution could be used as a coating solution because the ammonium and chloride ions in the solution could be removed during annealing of the films. Further purification to remove the ammonium chloride was done by placing the solution in an Amicon filtration unit containing a 10,000 molecular weight filter designed to pass materials having a molecular weight less than 10,000 grams/mole. The solution was diluted to 200 mL and then concentrated to 10 mL in volume. Inductively coupled plasma-atomic emission spectroscopy showed that the final solution was 206 mM in Ge. The pH of the solution was 5.8.

An amount of 2 mL of 206 mM Ge solution was poured into a ceramic boat. The solution was heated on a hot plate at 100° C. for several hours until a thick gel body formed. The boat was then heated in a tube furnace under a flow of a gas mixture of H₂ (4%) and N₂ (96%) at a ramp rate of 1 degree Celsius per minute (1°/min) according to the following procedure: the temperature was ramped to 120° C. and then held at 120° C. for 1 hour, then ramped to 350° C. and held at 350° C. for 1 hour, and ramped to 900° C. and held at 900° C. for 3 hours, before cooling back to room temperature. A dark brittle foam was produced.

### EXAMPLE 4

A foam of molybdenum and platinum (20%) was prepared according to the procedure that follows. An amount of 0.552 grams of ammonium molybdate tetrahydrate, which has the formula (NH₄)₆Mo₇O₂₄.4H₂O, was dissolved in 15 mL of water. An amount of 0.828 grams of H₄EDTA and an amount of 0.820 grams of PEI were added to the solution. The resulting mixture was mixed using a vortex mixer for several minutes which resulted in a clear pale blue solution which was used right away.

An amount of 1 gram of platinum diamine dichloride, which has the formula Pt(NH₃)₂Cl₂, was dissolved in 10 mL of a 30% aqueous solution of polyacrylic acid by stirring at room temperature for several hours. The solution was diluted with water to yield a final concentration of platinum of 143 mM.

A 16 mL portion of the molybdenum solution was combined with a 0.990 mL portion of the 143 mM platinum solution and poured into a ceramic boat. The solution was heated on a hot plate at 100° C. overnight which resulted in a thick gel body. The boat was then heated in a tube furnace under a flow of a gas mixture of H₂ (4%) and N₂ (96%) at a ramp rate of 1 degree Celsius per minute (1°/min) according to the following procedure: the temperature was ramped to 120° C. and then held at 120° C. for 1 hour, then ramped to 350° C. and held at 350° C. for 1 hour, and ramped to 700° C. and held at 700° C. for 3 hours, before cooling back to room temperature. A dark brittle foam was produced.

### EXAMPLE 5

A foam of molybdenum nitride and molybdenum carbide was prepared according to the procedure that follows. An amount of 0.552 grams of ammonium molybdate tetrahydrate was dissolved in 15 mL of water. An amount of 1.67 grams of H₄EDTA and an amount of 0.854 grams of PEI were added to the solution. The resulting mixture was mixed using a vortex mixer for several minutes which resulted in a clear, pale yellow solution, which was used right away.

An amount of 5 mL of the molybdenum solution was poured into a ceramic boat. The ceramic boat was heated at 100° C. on a hot plate overnight which produced a thick gel body. The boat was then heated in a tube furnace under a flow of a gas mixture of H₂ (4%) and N₂ (96%) at a ramp rate of 5 degrees Celsius per minute (5°/min) to a temperature of 950° C. and then held at 950° C. for 3 hours before cooling back to room temperature. A dark brittle foam of molybdenum nitride and molybdenum carbide, and with a surface area of 77 m²/g was produced.

### EXAMPLE 6

A foam of titanium oxide (TiOₓ) where 1<x<2, was prepared according to the procedure that follows. A solution of soluble titanium was prepared by placing an amount of 2.5 grams of 30% hydrogen peroxide into 30 mL of nanopure water and then, in a fume hood, slowing adding an amount of 2.5 grams titanium tetrachloride.

A second solution was prepared by mixing an amount of 2 grams H₄EDTA and an amount of 2 grams PEI into 30 mL of water. Small aliquots of the titanium solution were then added to the PEI/EDTA solution. The pH was monitored. As the pH decreased below a pH of 3.5, small aliquots of 10% NH₄OH were added to raise the pH to 7.5. This process was repeated until addition of a drop of the titanium solution resulted in precipitate that would not dissolve. The solution was then filtered through a 0.45 micron filter and then was placed in an Amicon filtration unit containing a PM 10 filter designed to pass materials having a molecular weight less than 10,000 grams/mole. The solution was diluted to 200 mL and then concentrated to 20 mL in volume. Inductively coupled plasma-atomic emission spectroscopy showed that the final solution was 211 mM in Ti.

An amount of 5 mL of the 211 Ti solution was poured into a ceramic boat. The ceramic boat was heated at 100° C. on a hot plate overnight which produced a thick gel body. A tube furnace containing the boat was purged for 45 minutes at 20 sccm with a flow of a gas mixture of H₂ (4%) and N₂ (96%) prior to starting a heating program. Under the same flow of the same gas mixture, at a ramp rate of 5 degrees Celsius per minute (5°/min) the boat was heated to a temperature of 950° C. and then held at 950° C. for 3 hours before cooling back to room temperature. A dark brittle foam of titanium oxide (TiOₓ) where 1<x<2, and with a surface area of 200 m²/g was produced.

### EXAMPLE 7

A foam of TiO was prepared according the procedure that follows. A solution of soluble titanium was prepared by placing an amount of 2.5 grams of a 30% solution of hydrogen peroxide into 30 mL of nanopure water and then slowly adding an amount of 2.5 grams of titanium tetrachloride to the peroxide. This addition was performed in a fume hood because HCl vapors are produced during the addition of the titanium tetrachloride.

A solution of PEI/EDTA was prepared by mixing an amount of 2 grams of H₄EDTA and an amount of 2 grams of PEI in 30 mL of water.

Small aliquots of the titanium solution were added to the PEI/EDTA solution and the pH was monitored. As the pH increased above a pH of 3.5, small aliquots of 10% NH₄OH solution were added to raise the pH to a pH of 7.5. This process was repeated until addition of a drop of the titanium solution resulted in precipitate that would not dissolve. The solution was then filtered through a 0.45 micron filter and was placed in an Amicon filtration unit containing a PM 10 filter designed to pass materials having a molecular weight less than 10,000 grams/mole. The solution was diluted to 200 mL and then subjected to ultrafiltration, which resulted in concentration to a final volume of 20 mL. Inductively coupled plasma-atomic emission spectroscopy showed that the final solution was 211 mM Ti.

An amount of 5 mL of the 211 Ti solution was poured into a ceramic boat, which was heated on a hot plate at 100° C. overnight, which produced a thick gel body. The boat was placed into a tube furnace, which was purged for 1 hour with 100 sccm of a flowing gas mixture of 6% H₂ and 94% N₂ prior to starting a heating program. Under the same flowing gas mixture at a ramp rate of 5°/min, the boat was heated up to 950° C. and held for 3 hours at 8 hours at 950° C. before cooling it back to room temperature. A dark brittle foam of TiO was produced with a surface area of 286 m²/gram.

### EXAMPLE 8

A foam of TiO₂ was prepared according the procedure that follows. A solution of soluble titanium was prepared by placing an amount of 2.5 grams of 30% hydrogen peroxide into 30 mL of nanopure water and then slowing adding an amount of 2.5 grams of titanium tetrachloride. The addition was done in a fume hood because HCl vapors are produced.

A second solution was prepared by mixing an amount of 2 grams of H₄EDTA and an amount of 2 grams of PEI in 30 mL of water. Small aliquots of the soluble titanium solution were added to the second solution. The pH was monitored. As the pH decreased below 3.5, aliquots of NH₄OH were added to increase the pH to 7.5. This was repeated until addition of a drop of titanium solution resulted in a precipitate that would not dissolve. The solution was then filtered through a 0.45 micron filter. The filtrate was placed in an Amicon filtration unit containing a PM 10 filter designed to pass materials having a molecular weight less than 10,000 grams/mole. The solution was diluted to 200 mL and subjected to ultrafiltration, resulting in concentration to a volume of 20 mL. Inductively coupled plasma-atomic emission spectroscopy was used to determine the final concentration of soluble Ti, which was 294 mM Ti.

An amount of 5 mL of the 294 mM Ti solution was poured into a ceramic boat. The solution was heated on a hot plate at 100° C. overnight, which produced a thick gel body. The ceramic boat and gel body were placed in a tube furnace under a flow of air and heated to 120° C. at a ramp rate of 1°/minute. The temperature was maintained at 120° C. for 1 hour. The temperature was then increased to 350° C. at a ramp rate of 1°/minute. The temperature was maintained at 350° C. for 1 hour. The temperature was then increased to 700° C. at a ramp rate of 1°/minute and held at 700° C. for 3 hours, and then allowed to cool to room temperature. The product was a white foam of TiO₂ with a surface area of 252 m²/gram.

### EXAMPLE 9

A foam of ZrO₂ was prepared according to the procedure that follows. A solution including soluble Zr was prepared by dissolving an amount of 1.54 grams of H₄EDTA in 20 mL of water, then adding an amount of 2.97 grams of zirconyl nitrate (35 wt% in water) followed by stirring, and then adding an amount of 1 gram of PEI and stirring. Several drops of dilute ammonia were added until a clear solution was formed. The pH of the clear solution was pH 8.0. This clear solution was placed in an Amicon ultrafiltration unit containing a PM 10 ultrafiltration membrane designed to pass materials having a molecular weight less than 10,000 grams/mole. The solution was diluted to 200 mL with absolute ethanol and then subjected to ultrafiltration, resulting in a final volume of 10 mL which contained 19.3 mg/mL of soluble Zr by inductively coupled plasma-atomic emission spectroscopy.

An amount of 5 mL of the soluble Zr solution was poured into the ceramic boat. The boat and solution in the boat were heated on a hot plate at 100° C. overnight, which resulted in a thick gel body. The ceramic boat and gel body were placed in a tube furnace under a flow of air and heated to 120° C. at a ramp rate of 1°/minute. The temperature was maintained at 120° C. for 1 hour. The temperature was then increased to 350° C. at a ramp rate of 1°/minute. The temperature was maintained at 350° C. for 1 hour. The temperature was then increased to 700° C. at a ramp rate of 1°/minute and held at 700° C. for 3 hours, and then allowed to cool to room temperature, yielding white foam of ZrO₂.

### EXAMPLE 10

A foam of zinc oxide was prepared according to the procedure that follows. A solution containing soluble zinc was prepared by dissolving an amount of 2.0 grams of K₂H₂EDTA in 30 mL of water, then adding an amount of 0.75 grams of zinc chloride and stirring, then adding 0.75 grams of PEI, and then adjusting the pH of the solution to pH 9 by adding 10% HCl. The resulting solution was placed in an Amicon ultrafiltration unit containing a PM 10 ultrafiltration membrane designed to pass materials having a molecular weight less than 10,000 grams/mole. The solution was diluted to a volume of 200 mL and then subjected to ultrafiltration, resulting in a concentrated solution having a volume of 20 mL. Inductively coupled plasma—atomic emission spectroscopy was used to determine that the solution containing soluble zinc had 24.2 mg/mL of Zn.

An amount of 5 mL of the soluble Zn solution was poured into a ceramic boat. The boat and solution in the boat were heated on a hot plate at 100° C. overnight, which resulted in a thick gel body. The ceramic boat and gel body were placed in a tube furnace under a flow of air and heated to 120° C. at a ramp rate of 1°/minute. The temperature was maintained at 120° C. for 1 hour. The temperature was then increased to 350° C. at a ramp rate of 1°/minute. The temperature was maintained at 350° C. for 1 hour. The temperature was then increased to 700° C. at a ramp rate of 1°/minute and held at 700° C. for 3 hours, and then allowed to cool to room temperature, yielding a white foam of ZnO₂.

### EXAMPLE 11

A foam of RuO₂ was prepared according to the procedure that follows. An amount of 0.977 grams of EDTA was dissolved in 5 mL of water. An amount of 0.231 grams of ruthenium chloride was added to the solution and after stirring an amount of 1.2 grams of PEI was added. 30% ammonia in water was added dropwise until a clear solution formed, which was stirred for 2 hours. The clear solution was placed into a ceramic boat and heated on a hot plate at 100C overnight, which produced a gel body.

Under an atmosphere of air, the ceramic boat and gel body were heated to 120° C. at a ramp rate of 1°/minute. The temperature was maintained at 120° C. for 1 hour. The temperature was then increased to 350° C. at a ramp rate of 1°/minute. The temperature was maintained at 350° C. for 1 hour. The temperature was then increased to 700° C. at a ramp rate of 1°/minute and held at 700° C. for 3 hours, and then allowed to cool to room temperature, yielding a black conductive foam of RuO₂.

### EXAMPLE 12

A foam of RuO₂ was prepared according to the procedure that follows. An amount of 1.25 grams of ruthenium chloride was dissolved in 10 mL of absolute ethanol. The solution was stirred for 2 hours and then filtered. An amount of 0.625 mL of the filtrate was added to 0.25 mL of a 25 wt% polyacrylic acid solution in water. This mixture was allowed to stand overnight to form a gel body.

The gel body was transferred to a ceramic boat. The ceramic boat and gel body were placed in a tube furnace under a flow of air and heated to 120° C. at a ramp rate of 1°/minute. The temperature was maintained at 120° C. for 1 hour. The temperature was then increased to 350° C. at a ramp rate of 1°/minute. The temperature was maintained at 350° C. for 1 hour. The temperature was then increased to 700° C. at a ramp rate of 1°/minute and held at 700° C. for 3 hours, and then allowed to cool to room temperature, yielding a black conductive foam of RuO₂.

### EXAMPLE 13

A foam of aluminum oxide was prepared according to the procedure that follows. An amount of 2 grams of H₄EDTA was placed in a 50 mL Falcon tube and 20 mL of nanopure water was added. The H₄EDTA does not dissolve at this stage. An amount of 2/0 grams of aluminum nitrate nonahydrate was added, followed by 2.2 grams of polyethyleneimine (BASF) and the mixture was agitated until everything dissolved. After stirring, the solution was placed in an Amicon filtration unit containing a PM 10 filter designed to pass materials having a molecular weight less than 10,000 grams/mole. The solution was diluted to 200 mL and then subjected to ultrafiltration, which produced a concentrated solution having a volume of 10 ML that was 119 mM of soluble aluminum.

An amount of 5 mL of the concentrated 119 mM aluminum solution was poured into a ceramic boat and heated on a hot plate on a hot plate at 100C overnight to form a gel body. The ceramic boat and gel body were placed in a tube furnace under a flow of air and heated to 120° C. at a ramp rate of 1°/minute. The temperature was maintained at 120° C. for 1 hour. The temperature was then increased to 350° C. at a ramp rate of 1°/minute. The temperature was maintained at 350° C. for 1 hour. The temperature was then increased to 700° C. at a ramp rate of 1°/minute and held at 700° C. for 3 hours, and then allowed to cool to room temperature, yielding a grey foam of aluminum oxide.

### EXAMPLE 14

A foam of uranium oxide was prepared according to the procedure that follows. A soluble uranium solution was prepared first. An amount of 1.67 grams of H₄EDTA was placed in a 50 mL Falcon tube and 10 mL of nanopure water was added. An amount of 0.211 mL of a solution of 1.99 M uranyl nitrate was added, and then an amount of 1.7 grams of polyethyleneimine (BASF) was added. The mixture was agitated and the pH was adjusted to a pH of 7 by adding dilute HCl. The result was a soluble uranium solution. If too much HCl were added and the pH decreases below 7, then addition of dilute ammonia neutralizes the excess acid to return to a pH of 7.

An amount of 5 mL of the soluble uranium solution was poured into a ceramic boat and heated on a hot plate on a hot plate at 100° C. overnight to form a gel body. The ceramic boat and gel body were placed in a tube furnace under a flow of air and heated to 120° C. at a ramp rate of 1°/minute. The temperature was maintained at 120° C. for 1 hour. The temperature was then increased to 350° C. at a ramp rate of 1°/minute. The temperature was maintained at 350° C. for 1 hour. The temperature was then increased to 700° C. at a ramp rate of 1°/minute and held at 700° C. for 3 hours, and then allowed to cool to room temperature, yielding a black foam.

### EXAMPLE 15

A foam of uranium nitride was prepared according to the following procedure. A soluble uranium solution was prepared first. An amount of 1.67 grams of H₄EDTA was placed in a 50 mL Falcon tube and 10 mL of nanopure water was added. An amount of 0.211 mL of a solution of 1.99 M uranyl nitrate was added, and then an amount of 1.7 grams of polyethyleneimine (BASF) was also added. The mixture was agitated and the pH was adjusted to a pH of 7 by adding dilute HCl. The result is a soluble uranium solution.

If too much HCl is added and the pH decreases below 7, then addition of dilute ammonia neutralizes the excess acid to return to a pH of 7.

An amount of 5 mL of the soluble uranium solution was poured into a ceramic boat and heated on a hot plate on a hot plate at 100C overnight to form a gel body. The ceramic boat and gel body were placed in a tube furnace under a flow of a gas mixture of 4% H₂ and 96% N₂ and heated to 120° C. at a ramp rate of 1°/minute. The temperature was maintained at 120° C. for 1 hour. The temperature was then increased to 350° C. at a ramp rate of 1°/minute. The temperature was maintained at 350° C. for 1 hour. The temperature was then increased to 700° C. at a ramp rate of 1°/minute and held at 700° C. for 3 hours, and then allowed to cool to room temperature, yielding a black foam of uranium nitride.

### EXAMPLE 16

A foam of elemental copper was prepared according to the procedure that follows. An amount of one gram of H₄EDTA was placed in a 50 mL Falcon tube and 25 mL of water was added. An amount of one gram of PEI (BASF) was added and the mixture was agitated until everything dissolved to form a solution. An amount of 0.85 grams of copper nitrate trihydrate were added to the solution. After stirring, the solution was placed in an Amicon ultrafiltration unit containing a PM 10 ultrafiltration membrane designed to pass materials having a molecular weight less than 10,000 grams/mole. The solution was diluted to a volume of 200 mL and then subjected to ultrafiltration, which produced a concentrated solution of soluble copper having a volume of 10 mL.

An amount of 5 mL of the concentration solution of soluble copper was placed in a ceramic boat, which was heated on a hot plate at 100° C. overnight to form a gel body. The ceramic boat and gel body were placed in a tube furnace under a flow of a gas mixture of 4% H₂ and 96% N₂ and heated to 120° C. at a ramp rate of 1°/minute. The temperature was maintained at 120° C. for 1 hour. The temperature was then increased to 350° C. at a ramp rate of 1°/minute. The temperature was maintained at 350° C. for 1 hour. The temperature was then increased to 700° C. at a ramp rate of 1°/minute and held at 700° C. for 3 hours, and then allowed to cool to room temperature, yielding a dark metallic foam.

### EXAMPLE 17

A foam of copper selenide was prepared as follows: An amount of one gram of H₄EDTA was placed in a 50 mL Falcon tube and 25 mL of water was added. The H₄EDTA did not dissolve at this stage. An amount of one gram of polyethyleneimine (BASF) was added and the mixture was agitated until everything dissolved to form a solution. An amount of 0.85 grams of copper nitrate trihydrate were added to the solution. After stirring, the solution was placed in an Amicon ultrafiltration unit containing a PM 10 ultrafiltration membrane designed to pass materials having a molecular weight less than 10,000 grams/mole. The solution was diluted to a volume of 200 mL and then subjected to ultrafiltration, which produced a concentrated solution of soluble copper having a volume of 10 mL.

An amount of 5 mL of the concentration solution of soluble copper was placed in a ceramic boat, which was heated on a hot plate at 100C overnight to form a gel body. The ceramic boat and gel body were placed in a tube furnace under a flow of a gas mixture of 6% H₂ and 94% Ar and heated to 120° C. at over a period of 8 hours. The temperature was increased to 450° C. at a ramp rate of 1°/minute. The temperature was maintained at 450° C. for 2 hours. When the temperature had stabilized at 450° C. a flow of diethylselenide was applied for 2 hours. Upon cooling to room temperature the tube was flushed with argon and the sample removed to yield copper selenide foam.

### EXAMPLE 18

A foam of copper indium selenide was prepared as follows: An amount of one gram of ethylenediaminetetraacetic acid was placed in a 50 mL Falcon tube and 25 mL of water was added. The ethylenediaminetetraacetic acid did not dissolve at this stage. An amount of one gram of polyethyleneimine (BASF) was added and the mixture was agitated until everything dissolved to form a solution. An amount of 0.85 grams of copper nitrate trihydrate were added to the solution. After stirring, the solution was placed in an Amicon ultrafiltration unit containing a PM 10 ultrafiltration membrane designed to pass materials having a molecular weight less than 10,000 grams/mole. The solution was diluted to a volume of 200 mL and then subjected to ultrafiltration, which produced a concentrated solution of soluble copper having a volume of 10 mL.

A solution including indium nitrate, ethylenediaminetetraaceticacid and polyethylenimine was prepared as follows. One gram of ethylenediaminetetraaceticacid was placed in a 50 mL Falcon tube and 25 mL of water were added. The ethylenediaminetetraaceticacid does not dissolve at this stage. One gram of polyethylenimine was added to the solution and the solution was agitated until the ethylenediaminetetraaceticacid and the polyethylenimine were in solution. Then 1.00 grams of indium nitrate were added. After stirring the solution was placed in an Amicon ultrafiltration unit containing a PM 10 ultrafiltration membrane designed to pass materials having a molecular weight <10,000 g/mol. The solution was diluted to 200 mL and then concentrated to 10 mL in volume. Inductively coupled plasma-atomic emission spectroscopy showed that the final solution had 14.2 mg/mL of In.

The copper solution and the indium solution were mixed together in equimolar proportion to give a 5 mL solution which was placed in a ceramic boat, which was heated on a hot plate at 100° C. overnight to form a gel body. The ceramic boat and gel body were placed in a tube furnace under a flow of a gas mixture of 6% H₂ and 94% Ar and heated to 120° C. at over a period of 8 hours. The temperature was increased to 450° C. at a ramp rate of 1°/minute. The temperature was maintained at 450° C. for 2 hours. When the temperature had stabilized at 450° C. a flow of diethylselenide was applied for 2 hours. Upon cooling to room temperature the tube was flushed with argon and the sample removed to yield copper indium selenide foam.

In the EXAMPLES above, the gel body was formed in a container, and the gel body and container were transferred to a tube furnace. It should be understood that the gel body may also be transferred to a different container with a different shape that may still provide the gel body with a surface area to volume ratio no higher than 10.

Although the present invention has been described with reference to specific details, it is not intended that such details should be regarded as limitations upon the scope of the invention, except as and to the extent that they are included in the accompanying claims.

What is claimed is:

1. A process for preparing an inorganic foam, comprising:
preparing a solution including a soluble metal precursor, a soluble polyethyleneimine, a suitable solvent, and a material selected from ethylenediaminetetraacetic acid or salt thereof,
subjecting the solution to ultrafiltration to produce a concentrated solution,
heating the concentrated solution in a container to form a gel body having a surface area to volume ratio no higher than 10,
heating the gel body in the container at temperatures sufficient to remove the solvent, remove the polyethyleneimine, and at a rate sufficient to generate gas from the polyethyleneimine and ethylenediaminetetraacetic acid or salt thereof, whereby an inorganic foam is produced.

2. The process of claim 1, wherein the soluble polyethyleneimine comprises polyethyleneimine and derivatives of polyethyleneimine.

3. The process of claim 1, wherein the soluble metal precursor comprises a metal selected from tin, vanadium, nickel, germanium, molybdenum, platinum, titanium, zirconium, zinc, ruthenium, aluminum, uranium, copper, and mixtures thereof

4. The process of claim 1, wherein the heating of the gel body occurs under a flowing gas.

5. The process of claim 4, wherein the flowing gas comprises oxygen and the inorganic foam is a metal oxide foam.

6. The process of claim 4, wherein the flowing gas comprises nitrogen and the inorganic foam is a metal nitride foam.

7. The process of claim 4, wherein the flowing gas comprises hydrogen and inorganic foam is a metal foam.

8. The process of claim 7, wherein the metal foam is a copper foam or a germanium foam.

9. The process of claim 4, wherein the flowing gas comprises hydrogen, the soluble metal comprises molybdenum or uranium, and the inorganic foam is a mixture of a carbide and a nitride.

10. The process of claim 4, wherein the flowing gas comprises carbon and the inorganic foam is a metal carbide.

11. The process of claim 10, wherein the flowing gas comprises ethylene.

12. The process of claim 4, wherein the flowing gas comprises selenium and the inorganic foam is a metal selenide.

13. A process for preparing an inorganic foam, comprising:
preparing a solution including a soluble metal precursor, a soluble polyethyleneimine, a suitable solvent, and a material selected from ethylenediaminetetraacetic acid and a salt thereof,
heating the concentrated solution in a container to form a gel body having surface to volume ratio no greater than 10,
heating the gel body in the container at temperatures sufficient to remove the solvent, remove the polyethyleneimine, and at a sufficient rate to generate gas from the polyethyleneimine and ethylenediaminetetraacetic acid or salt thereof, whereby an inorganic foam is produced.

14. A foam having a surface area greater than 10 meters square per gram and having a composition selected from the group of (a) molybdenum carbide and molybdenum nitride, (b) TiO, (c) copper selenide, (d) copper indium selenide, (e) molybdenum carbide, molybdenum nitride, and platinum, and (f) ruthenium dioxide.
